(19) United States
(12) Patent Application Publication
(10) Pub. No.: US 2003/0137164 A1
(43) Pub. Date: Jul. 24, 2003

(54) Automobile with washable interior

(76) Inventors: Jessica A. Schickel, Cleveland Heighs, OH (US); Chris T. Vild, Cleveland Heights, OH (US)

Correspondence Address: Jessica A. Schickel, 2585 Idle Wood Road, Clevelands Heights, OH, 44118, US

(21) Appl. No.: 10/350,981

(22) Filed: Jan. 24, 2003

Related U.S. Application Data
(60) Provisional application No. 60/350,441, filed on Jan. 24, 2002.

(51) Int. Cl. B60N 2/00

(52) U.S. Cl. 296/208

(57) ABSTRACT

A washable car or truck interior has been invented to allow easy cleaning with the use of a water hose. Washing can be done using direct water flow from a common garden hose on to the interior surfaces which until now would not be possible The invention is comprised of a closeable drain which is located on the interior floor. The floor is sloped toward the drain. Seats have horizontal surfaces that are curved as to not allow water to collect and pool. The dashboard and rear shelf surfaces slope toward floor, which is also sloped toward the drain. After the interior surfaces are washed, the water or soap and water is flows out of the care though the closeable drainage holes located in the lowest part of the interior floor.

### CROSS REFERENCE TO RELATED APPLICATIONS

This application is entitled to the benefit of Provisional Patent Application Serial No. 60/350,441 filed, Jan. 24, 2002

### BACKGROUND

1. Field of the Invention

This invention relates to Automobiles and Trucks, specifically passenger interiors and compartments.

2. Description of Prior Art

While much development has taken place in the field of automobile washing and cleaning, one aspect of that remains underdeveloped and misunderstood is the problem of washing and cleaning the interior of the automobile and the design of the interior for ease of washing and cleaning.

Much of the prior art relating to the washing and cleaning of automobile interiors relies on the mechanical tools for vacuuming the interior surfaces. Some prior art for interiors use protective, replaceable, plastic covers on areas that are exposed to dirt and garbage such as floor mats and seat covers. With all these designs and methods, the small crevasses and the surfaces under the plastic covers become stained or caked with dirt and debris. There are also inaccessible areas that can't be cleaned without expensive professional auto detailing. Unlike the exterior, interiors can not be easily cleaned with a common garden hose and soap. Any substantial amount of water or soap (the most effective method of washing), would pool in the interior crevices and bottom surfaces making it swampy and eventually moldy, causing permanent damage.

With the multiple uses of today's vehicles, for carpooling and pet transport, as traveling offices and for extreme sports, the need for an easily washable interior has become paramount and is heretofore unmet.

### OBJECT OF THE INVENTION

The object of the invention is to create an automotive interior that can withstand the rigors of direct wet washing and cleaning.

### DESCRIPTION OF DRAWINGS

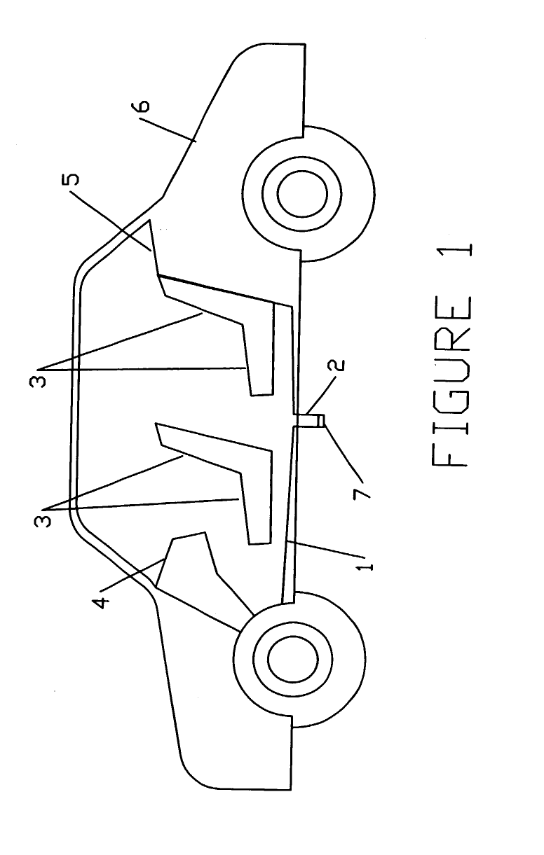

The FIG. 1 shows automobile 6 with drain 2 with valve on the drain 7 positioned at the lowest interior surface. Seat surfaces 3 and dashboard top surface 4 and back shelf 5 all slant toward the drain.

### DESCRIPTION OF THE INVENTION

The invention is comprised of an automobile with a closeable drain 1, which is located on the interior floor 2. The Floor 1 is sloped toward the drain. Seats 3 have slightly sloped horizontal surfaces that prevent water from collecting and pooling, and which allow water to run off onto the floor. Dashboard 4 and rear shelf 5 surfaces slope toward floor 1.

Operation on the Invention

In the preferred embodiment of the invention, all interior vents and exposed electronics would be closed and sealed. Next, the bottom drain would be opened. Then the non-waterproof, removable cushions, if any, would be removed or stowed. At this point the interior of the car could be washed with a hose and soap, much the way the exterior of the car is traditionally washed. After the interior is washed, and all water has drained out through the drain portal, it would be plugged. The plug would prevent water or air from entering the car through the opening during normal driving use.

In and alternative embodiment, the interior automobile design would include seal-able, waterproof materials, closeable vents, rubberized flooring and other waterproofing elements, with runoff water flow directed toward an interior, center, closeable drain.

In an additional alternative embodiment, the invention would include an automobile with a washable trunk. The truck space would include side and bottom surfaces sloping toward a drain at the lowest point in the trunk. The drain would be closable from inside the trunk so as to be easily accessible during washing

1. A passenger car or truck with an interior comprising:
a. a waterproof interior cabin,
b. one or more closeable drains in lowest surface of the interior,
c. interior surfaces sloping toward said drains.

2. The passenger car or truck of claim 1 with pivoting seats that tilt.

3. The passenger car or truck of claim 1 where said valve is connected to a tube which discharges away from the drain and valve.

4. The passenger car or truck of claim 1 where said valve has a spring loaded hinge at the bottom of the drain that opens to let the water out but would be normally closed.

5. The passenger car or truck of claim 1 where said valve is electronically activated from said interior.

6. The passenger car or truck of claim 1 where said drain is connected to a pump that pumps water out of said interior.

7. The passenger car or truck of claim 1 with removable seat cushions.

8. The passenger car or truck of claim 1 where the interior surfaces are rubberized.

9. The passenger car or truck of claim 1 where the interior surfaces are non-porous.

10. A passenger car or truck with a trunk comprising
a. a waterproof trunk interior,
b. one or more closeable drains in lowest surface of said interior,
c. Interior surfaces sloping toward said drains.

11. The passenger car or truck of claim 10 where the interior surfaces are non-porous.

12. A passenger car or truck with an interior comprising:
a. a waterproof interior cabin,
b. one or more closeable drains in lowest part of said interior,
c. surfaces sloping toward said drains,
d. one or more interior storage compartments with bottom drainage holes,
e. drainage holes discharging onto the bottom surfaces said interior cabin.

13. The passenger car or truck of claim 12 with pivoting seats that tilt.

14. The passenger car or truck of claim 12 where said valve is connected to a tube which discharges away from the drain and valve.

15. The passenger car or truck of claim 12 where said valve has a spring loaded hinge at the bottom of the drain that opens to let the water out but would be normally closed.

16. The passenger car or truck of claim 12 where said valve is electronically activated from said interior.

17. The passenger car or truck of claim 12 where said drain is connected to a pump that pumps water out of said interior.

18. The passenger car or truck of claim 12 with removable seat cushions.

19. The passenger car or truck of claim 12 where the interior surfaces are rubberized.

20. The passenger car or truck of claim 12 where the interior surfaces are non-porous.
